(19) United States
(12) Patent Application Publication
(10) Pub. No.: US 2024/0065227 A1
(43) Pub. Date: Feb. 29, 2024

(54) Dog Exercise and Entertainment Toy

(71) Applicant: Alexander Venturoso, Hacienda Heights, CA (US)

(72) Inventor: Alexander Venturoso, Hacienda Heights, CA (US)

(21) Appl. No.: 17/894,425

(22) Filed: Aug. 24, 2022

(51) Int. Cl. A01K 15/02; B05B 1/04; B05B 15/625

(52) U.S. Cl. CPC A01K 15/025; B05B 1/04; B05B 15/625

(57) ABSTRACT

A dog toy has two hoses having fixed ends connected to a weighted base through a “Y”. The hoses include an inner tube carrying water and an outer tube protecting the inner tube from dog bites. Free hose ends preferably include fan nozzles producing a wide spray.

### BACKGROUND OF THE INVENTION

The present invention relates to animal toys and in particular to a water exercise and entertainment toy for dogs.

Dogs often become bored and destructive, and some breeds need exercise to remain healthy and out of trouble. Various toys have been developed to satisfy this need, but none have been sufficiently successful to be universally accepted.

U.S. Pat. No. 7,997,229 discloses a sprinkler entertaining dogs, but merely sprays a fixed pattern, and state that dog toys with moving hoses will be quickly destroyed by dogs. Toys like that disclosed in the '229 patent fail to attract sufficient interest and may be quickly destroyed.

### BRIEF SUMMARY OF THE INVENTION

The present invention addresses the above and other needs by providing a dog toy having two hoses having fixed ends connected to a weighted base through a “Y”. The hoses include an inner tube carrying water and an outer tube protecting the inner tube from dog bites. Free hose ends preferably include fan nozzles producing a wide spray.

In accordance with one aspect of the invention, there is provided a dog toy having silicone tubing covered by flexible plastic tubing. The silicone tubing is connected to a base to receive a flow of water and the flexible plastic tubing covers the silicone tubing preventing damage.

In accordance with another aspect of the invention, there is provided a dog toy having a weighted base. The total weight is preferably between four and eight pounds. The base preferably has a length and width of about 12 inches for stability. The hoses move in a random pattern and the weighted base prevents the base from falling over during use.

In accordance with another aspect of the invention, there is provided a dog toy having fan nozzles at free ends producing a wide fan spray. The wide fan spray presents a challenge to dogs versus a narrow stream spray because there is no single stream for the dogs to chase and wide fan spray is harder for dogs to avoid providing better coverage for cooling on hot days.

In accordance with another aspect of the invention, there is provided a dog toy having light weight hoses providing greater motion.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is a front view of a toy for dogs according to the present invention.

FIG. 1B is a side view of the toy for dogs according to the present invention.

FIG. 1C is a side view of a single hose embodiment of the toy for dogs according to the present invention.

FIG. 2 is a hose of the toy for dogs according to the present invention.

FIG. 3A is a front view of a nozzle of the toy for dogs according to the present invention.

FIG. 3B is a side view of the nozzle of the toy for dogs according to the present invention.

FIG. 3C is a top view of the nozzle of the toy for dogs according to the present invention.

FIG. 3D is a bottom view of the nozzle of the toy for dogs according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement, or typically within 10 percent of a stated value.

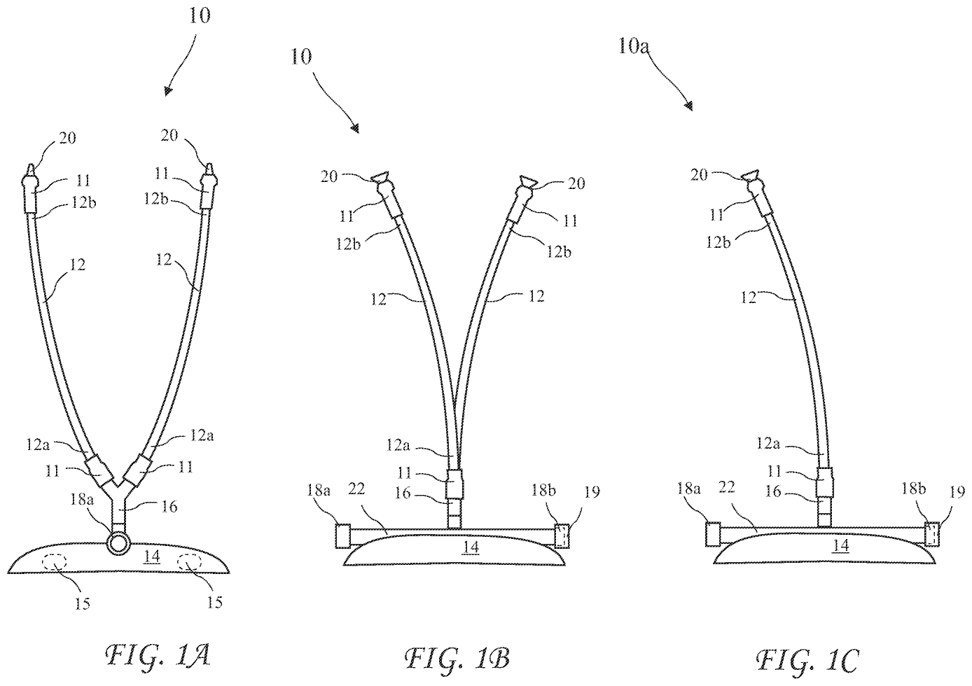

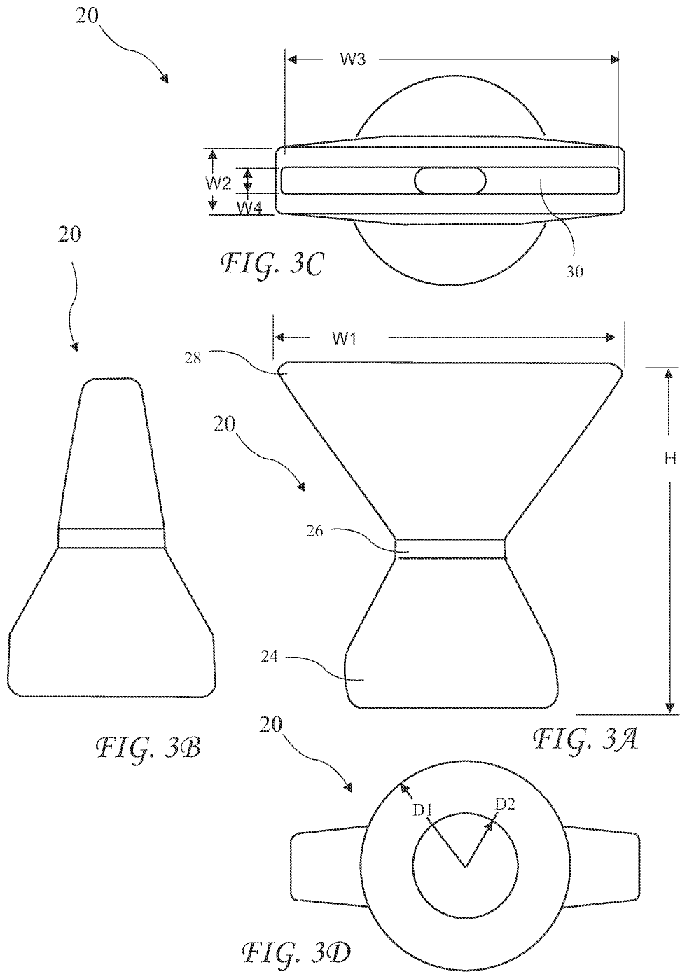

A front view of a toy 10 for dogs according to the present invention is shown in FIG. 1A and a side view of the toy 10 is shown in FIG. 1B. The toy 10 includes a base 14, a female garden hose connection 18a for receiving a flow of water, a passage 22 is in fluid communication with the connection 18a, and a “Y” fitting 16 is in fluid communication with the passage 22. Two hoses 12 have fixed ends 12a attached in fluid communication with the “Y” 16, and fee ends attached to nozzles 20 (details in FIGS. 3A-3D). Heat shrink tubing 11 helps seal the “Y” 16 and the nozzles 20 to the hoses 12.

The “Y” 16 may be fixed to the base 14, preferably by ½ inch male National Pipe Threads (NPT) engaging the base 14. The “Y” 16 may also rotate freely with respect to the base 14.

The base is preferably generally square with a length and width of about 12 inches. Weight 15 in the base 14 is preferably between four and eight pounds. A male garden hose connection 18b may be included opposite to the female garden hose connection 18a allowing several toys 10 to be connected in series. A cap 19 may close the male garden hose connection 18b when a single toy 10 is present. The “Y” 16 may be fixed to the base 14 or may be free to rotate.

A side view of a single hose embodiment 10a of the toy for dogs is shown in FIG. 1C. The toy 10a has all the features of the toy 10, but does not include the “Y” 16 and has only one hose 12.

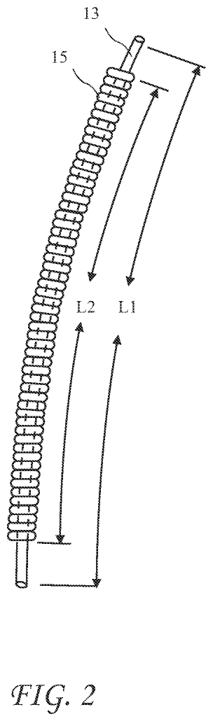

A hose 12 of the toy 10 is shown in FIG. 2. The hose 12 includes an inner hose 13 and an outer protective hose 15. The inner hose 13 is preferably a silicone tube preferably about 12 mm in outside diameter, and preferably 2 mm thick, and with a length L1. The length L1 is preferably between 54 cm and 70 cm, and more preferably 62 cm. The outer protective hose 15 is preferably plastic flexible corrugated tubing having an outside diameter of preferably about 18 mm and thickness of preferably about 0.3 mm, and a length L2. The length L2 is preferably about an inch shorter than the length L1. The hoses 13 and 15 may be smaller than the 12 mm and 18 mm in diameter, but preferably not greater than the 12 mm and 18 mm in diameter to allow a desired motion.

A front view of the nozzle 20 of the toy 10 is shown in FIG. 3A, a side view of the nozzle 20 is shown in FIG. 3B, a top view of the nozzle 20 is shown in FIG. 3C, and a bottom view of the nozzle 20 is shown in FIG. 3D. The design of the nozzle 20 is based on testing. A fan spray pattern offers a better dispersion of water that is more practical for a backyard water toy. A narrow jet stream pattern and other more narrow patterns are too aggressive for dogs and would spray the water too far away, posing an issue for small backyards. With the fan pattern the water is contained to a smaller area of approximately 12 feet in radius and approximately 8 feet high. A wider stream of water provides more effective cooling while dogs interact with the toy when compared to narrower streams of water. Further, it is possible that dogs can develop hyponatremia (water toxicity) from consuming large amounts of water. Although not a major concern to veterinarians, the risk of hyponatremia is reduced by the fan nozzle.

A base 24 of the nozzle 20 is generally round and has a diameter D1 slightly greater than the inner diameter of the inner hose 13, or preferably 16 mm. A waist 26 has an outside diameter D2 of preferably about 10 mm. A fan tip 28 has a first outside width W1 of preferably about 25 mm and a second outside width W2 of preferably about 5 mm. A mouth 30 in the fan tip 28 has a first mouth width W3 of preferably about 24 mm and a second mouth width W4 of preferably between 0.5 mm and 1.5 mm to provide a desired spray. The nozzle 20 has a height H of preferably about 25 mm.

While the invention herein disclosed has been described by means of specific embodiments and applications thereof, numerous modifications and variations could be made thereto by those skilled in the art without departing from the scope of the invention set forth in the claims.

I claim:

1. A dog toy, comprising:
a weighted base;
a water inlet in fluid communication with the a fluid passage of the base;
at least one hose having a fixed end attached in fluid communication with the passage, the at least one hose between 54 cm and 70 cm long; and
nozzles attached to a free end of each of the at least one hose in fluid communication with the water source serially through the passage and the hose.

2. The toy of claim 1, wherein the at least one hose is exactly two hoses.

3. The toy of claim 1, wherein the at least one hose is about 62 cm long.

4. The toy of claim 1, wherein the at least one hose comprises an inner hose and an outer hose, the inner hose in fluid communication with the passage.

5. The toy of claim 4, wherein the inner hose is a silicone tube.

6. The toy of claim 4, wherein the inner hose is 12 mm or less in diameter.

7. The toy of claim 5, wherein the outer hose is plastic hose protecting the inner hose.

8. The toy of claim 7, wherein the outer hose is plastic hose is a corrugated plastic hose.

9. The toy of claim 8, wherein:
the inner hose is 12 mm or less in diameter; and
the outer hose has a maximum diameter of 18 mm or less.

10. The toy of claim 8, wherein:
the inner hose is about 12 mm in diameter; and
the outer hose is about 18 mm in diameter

11. The toy of claim 1, wherein the nozzles are fan nozzles having a wide mouth.

12. The toy of claim 1, wherein the fan nozzles have a first mouth width (W3) of about 24 mm and a second mouth width (W4) of between 0.5 mm and 1.5 mm.

13. The toy of claim 1, wherein the passage has an inlet end with female garden hose fitting and an outlet end with a male garden hose fitting.

14. The toy of claim 1, wherein the weighted base weighs between four and eight pounds.

15. A dog toy, comprising:
a weighted base weighing between four and eight pounds;
a water inlet in fluid communication with the a fluid passage of the base;
two hoses having fixed ends attached in fluid communication with the passage, the two hoses between 54 cm and 70 cm long and comprising:
a silicone inner tube 12 mm or less outside diameter and about 2 mm thickness in fluid communication with the passage; and
a protective corrugated plastic outer tube around the inner tube and 18 mm or less in outside diameter and about 0.3 mm thickness.
nozzles attached to a free end of the two hoses in fluid communication with the water source serially through the passage and the inner tube, nozzles mouths having a first mouth width (W3) of about 24 mm and a second mouth width (W4) of between 0.5 mm and 1.5 mm.

15. A dog toy, comprising:
a weighted base weighing between four and eight pounds;
a water inlet in fluid communication with the a fluid passage of the base;
two hoses having fixed ends attached in fluid communication with the passage, the two hoses about 62 mm long and comprising:
a silicone inner tube about 12 mm in outside diameter and about 2 mm in thickness in fluid communication with the passage; and
a protective corrugated plastic outer tube around the inner tube, the outer tube about 18 mm in outside diameter and about 0.3 mm in thickness.
nozzles attached to a free end of the two hoses in fluid communication with the water source serially through the passage and the inner tube, nozzles mouths having a first mouth width (W3) of about 24 mm and a second mouth width (W4) of between 0.5 mm and 1.5 mm.
